(19) United States
(12) Patent Application Publication
(10) Pub. No.: US 2025/0115225 A1
(43) Pub. Date: Apr. 10, 2025

(54) METHOD AND DEVICE FOR OPERATING A HYDRAULIC BRAKE SYSTEM OF A MOTOR VEHICLE, BRAKE SYSTEM

(71) Applicant: Robert Bosch GmbH, Stuttgart (DE)

(72) Inventors: Benjamin Heinz, Eberstadt (DE); Jens Kolarsky, Bietigheim/Bissingen (DE); Konstantinos Gkoutzos, Neckarweihingen-Ludwigsburg (DE); Rafael Boehmler, Ludwigsburg (DE)

(21) Appl. No.: 18/904,144

(22) Filed: Oct. 2, 2024

(30) Foreign Application Priority Data
Oct. 10, 2023 (DE) 10 2023 209 867.9

(51) Int. Cl. B60T 13/74; B60T 13/14; B60T 13/58; B60T 13/68

(52) U.S. Cl. CPC B60T 13/745; B60T 13/142; B60T 13/588; B60T 13/686; B60T 2220/04; B60T 2270/402; B60T 2270/413

(57) ABSTRACT

A method for operating a hydraulic brake system of a motor vehicle. The brake system includes a hydraulic primary actuator, which includes a master brake cylinder and an actuator that can be controlled for operating the master brake cylinder, and at least one brake circuit that is or can be hydraulically connected to the master brake cylinder and has at least one hydraulically actuated wheel brake, wherein the at least one brake circuit comprises at least one secondary actuator and, assigned to the relevant wheel brake, at least one controllable inlet valve and at least one controllable outlet valve, wherein the secondary actuator can be controlled to convey hydraulic volume in the direction of the inlet valve, and wherein the at least one brake circuit comprises a hydraulic pressure accumulator connected downstream of the outlet valve.

### CROSS REFERENCE

The present application claims the benefit under 35 U.S.C. § 119 of German Patent Application No. DE 10 2023 209 867.9 filed on Oct. 10, 2023, which is expressly incorporated herein by reference in its entirety.

### FIELD

The present invention relates to a method for operating a hydraulic brake system of a motor vehicle, wherein the brake system comprises a hydraulic primary actuator, which comprises a master brake cylinder and an actuator that can be controlled for operating the master brake cylinder, and at least one brake circuit that is hydraulically or can be connected to the master brake cylinder and has at least one hydraulically actuated wheel brake, wherein the at least one brake circuit comprises at least one secondary actuator and, assigned to the wheel brake device, at least one controllable inlet valve and at least one controllable outlet valve, wherein the secondary actuator can be controlled to convey hydraulic volume in the direction of the inlet valve, and wherein the at least one brake circuit comprises a hydraulic pressure accumulator connected downstream of the outlet valve.

Furthermore, the present invention relates to a device for operating a hydraulic brake system of a motor vehicle, which comprises a control device, which is specially designed to carry out the above-mentioned method.

The present invention also relates to a brake system for a motor vehicle, which is designed as described above and comprises the above-mentioned control device.

### BACKGROUND INFORMATION

Methods and devices of the type mentioned above are generally described in the related art. Today's brake systems usually comprise a hydraulically operating master brake cylinder, which comprises a displaceably mounted hydraulic single piston or tandem piston, which can be displaced by an operator pressing a brake pedal. As a rule, the piston is mechanically coupled to the brake pedal, so that the driver can generate hydraulic pressure through the master brake cylinder in a hydraulic brake circuit connected thereto in any driving situation. A brake pressure generation or booster unit is often connected between the brake pedal and the master brake cylinder as a primary actuator, which assists the driver when applying the desired brake pressure or generates brake or hydraulic pressure by actuating the master brake cylinder independently of pedal actuation. In addition, modern motor vehicles usually comprise a brake system with an ESP (ESP=electronic stability program) module, which ensures the setting of wheel-specific brake pressures or braking forces, in order to optimize the driving stability of the motor vehicle, for example during braking or acceleration processes. If the brake pressure generation or booster unit fails, the ESP can usually take over its function with greatly reduced power. The brake pressure generated in the master brake cylinder by the driver is detected by the ESP module by means of a pressure sensor and, by suitable valve control and the control of a secondary actuator of the ESP system, a brake wheel pressure is set that exceeds the hydraulic pressure provided by the driver via the brake pedal. In this respect, the ESP module assists the driver during braking, as a result of which the pedal forces required if the primary actuator fails are reduced or the desired braking is ensured despite the failure of the primary actuator.

### SUMMARY

A method according to an example embodiment of the present invention may have the advantage over the conventional methods that brake pressure can be built up sufficiently rapidly even at low temperatures, at which the viscosity of the hydraulic medium decreases, and leads to an increased demand on the secondary actuator. According to an example embodiment of the present invention, this is achieved by carrying out the following steps in succession upon each startup of the motor vehicle: Initially, in a step a), a temperature of the hydraulic medium is ascertained or detected and compared with a predefined limit value.

Only if the ascertained temperature is below the limit value is the procedure continued with the following step b). If the temperature is above the limit value, the brake system continues to operate normally without the further steps. A temperature of −20° C., at least −10° C. or 0° C., for example, is assumed as the limit value. In particular, the limit temperature is selected in accordance with the temperature behavior of the hydraulic medium in such a way that the hydraulic medium reaches an undesirable stiffness at a temperature below the limit temperature. If the temperature is below the predefined limit value, the primary actuator is initially controlled to pump the hydraulic medium into the brake circuit, in order to fill the pressure accumulator to a predefined level with hydraulic volume. By controlling the primary actuator and the valves of the brake circuit, the hydraulic volume conveyed by the master brake cylinder can be fed to the pressure accumulator without generating brake pressure on one of the wheel brakes. This allows for efficient and rapid filling of the pressure accumulator.

Subsequently, in a step c), the functionality of the primary actuator and/or the master brake cylinder is monitored during operation of the motor vehicle. Thus, filling the pressure accumulator only serves as a preparatory measure for a fault, without the fault actually occurring or being expected.

Only if a malfunction of the primary actuator, in particular the master brake cylinder and/or the controllable actuator, is recognized is the secondary actuator controlled in a subsequent step d) in such a way that hydraulic volume is conveyed from the pressure accumulator through the secondary actuator in the direction of the inlet valve of the brake circuit into the at least one brake circuit. Instead of drawing in hydraulic volume from the master brake cylinder as before, the secondary actuator now conveys the hydraulic medium pre-filled in the pressure accumulator into the brake circuit. Since the pressure accumulator is usually arranged closer to the wheel brakes than the master brake cylinder in terms of hydraulic distance, a more rapid filling of the brake circuit or a more rapid provision of the desired brake pressure is effected at the inlet valves or at the wheel brake if the relevant inlet valve is opened. Pre-filling the pressure accumulator thus ensures that, if the primary actuator fails, pressure is built up rapidly in the brakes and, in particular, that the motor vehicle can be brought to a standstill rapidly and safely.

According to a preferred embodiment of the present invention, the primary actuator is controlled in step b) in such a way that the predefined volume is conveyed from the master brake cylinder into the pressure accumulator. The primary actuator is thus controlled in such a way that the desired amount of hydraulic medium is conveyed into the pressure accumulator, knowing the piston cross-section and the movement path of the hydraulic piston of the master brake cylinder. The pressure accumulator is designed in particular as a passive pressure accumulator with an elastically deformable spring element, wherein the pressure accumulator has in particular a maximum filling capacity. Preferably, the pressure accumulator is only partially filled by the primary actuator, rather than to the maximum, so that rapid brake pressure reduction remains possible during driving operation by opening an outlet valve and absorbing the hydraulic medium into the pressure accumulator.

According to an alternative embodiment of the present invention, the pressure accumulator is preferably initially completely filled by the primary actuator in step b) and subsequently emptied to the predefined level, in particular by controlling the secondary actuator. This is particularly advantageous if the brake pads move so smoothly that it is possible to distinguish whether the displaced hydraulic volume has been fed into the pressure accumulator or into the wheel brakes by completely filling the pressure accumulator, so that a defined pressure is achieved in the brake circuit, thus ensuring that both the brake pads (with the inlet valves open) are applied and the pressure accumulator is completely filled. If the pressure accumulator is now completely filled, the outlet valves or the outlet valve are closed and the primary actuator is moved to a starting position or rest position. Thereafter, the hydraulic volume that has been pushed too far into the pressure accumulator is extracted with the aid of the secondary actuator and pumped back to a hydraulic reservoir in the brake system.

According to a preferred further development of the present invention, in step d) a simple braking operation or an emergency braking operation is carried out in accordance with a detected braking request. In particular, a distinction is made between simple braking and emergency braking in accordance with the braking force applied by the driver and/or the actuation speed of the driver. If the braking force and/or actuation speed is high, emergency braking or panic braking is assumed. If the braking force and/or actuation speed is lower, a “normal” braking request is assumed and a simple braking operation is initiated.

Preferably, the brake system comprises at least two wheel brakes for the front wheels of the motor vehicle and at least two wheel brakes for the rear wheels of the motor vehicle, wherein for a simple braking operation, the hydraulic volume is conveyed by the secondary actuator into at least one wheel brake of the brake system. If the volume conveyed by the secondary actuator is distributed over many wheel brakes, the hydraulic force acting on the relevant wheel brake or the brake pressure acting in each case is reduced accordingly. Thus, in the case of a simple braking operation, a distribution to a plurality of wheel brakes can be carried out safely, provided that the braking request falls below a predefined limit value resulting from the structural design of the brake system.

According to an alternative embodiment of the present invention, the brake system comprises at least two wheel brakes for the front wheels of the motor vehicle and at least two wheel brakes for the rear wheels of the motor vehicle, wherein for a simple braking operation, the hydraulic volume is conveyed by the secondary actuator only into the wheel brakes for the front wheels. This is advantageous if, for example, the maximum hydraulic volume that can be conveyed by the secondary actuator is not sufficient to fill all the wheel brakes of the brake system simultaneously at sufficient speed and with sufficient pressure for fulfilling the braking request. In this case, only the hydraulic volume is conveyed to the wheel brakes for the front wheels, in order to achieve maximum braking effect there.

Optionally, according to an example embodiment of the present invention, it is preferably provided that in step d), an electromechanical parking brake, at least on the rear wheels of the motor vehicle, is additionally activated. In particular in the case where the hydraulic volume is only fed to the wheel brakes of the front wheels by the secondary actuator, the electromechanical parking brake advantageously assists the overall braking behavior of the motor vehicle and ensures that a braking request to decelerate the motor vehicle is achieved to the desired extent.

Furthermore, according to an example embodiment of the present invention, it is preferably provided that in step d), at least one changeover valve, which is connected between the at least one brake circuit and the master brake cylinder and is assigned to the secondary actuator on the pressure side, is closed. This prevents the hydraulic volume provided by the secondary actuator from being conveyed in the direction of the master brake cylinder, instead of in the direction of the relevant inlet valve. As a result, the operation of the brake system in step d) is optimized.

Furthermore, according to an example embodiment of the present invention, it is preferably provided that in step d), at least one hydraulic valve, which is connected between the at least one brake circuit and the master brake cylinder and is assigned to the secondary actuator on the suction side, is opened. As a result, it is ensured that the secondary actuator can draw hydraulic volume not only from the pressure accumulator on the suction side, but also from the master brake cylinder and/or a reservoir for hydraulic medium assigned to the master brake cylinder. As a result, the total hydraulic volume that can be drawn in in step d) increases.

Preferably, according to an example embodiment of the present invention, the hydraulic valve is only opened if the hydraulic medium stored in the pressure accumulator has already been conveyed into the brake circuit by the secondary actuator. This prevents the secondary actuator from drawing in hydraulic fluid from the reservoir or the master brake cylinder right from the start, which would be detrimental due to the low temperature of the hydraulic fluid and the large hydraulic distance to the reservoir and master brake cylinder.

Preferably, according to an example embodiment of the present invention, the brake system comprises at least two brake circuits, which are designed like the specified at least one brake circuit, wherein a plurality of, in particular each, or only one of the pressure accumulators of the at least two brake circuits is filled to the predefined level in step b). If the brake system comprises two brake circuits connected to the primary actuator, which in each case comprises two wheel brakes in particular, then preferably only one of the pressure accumulators or only the pressure accumulator of one of these brake circuits is filled to the predefined level. As a result, the preparation time of the brake system is reduced. In particular, the pressure accumulator of the brake circuit of which the wheel brakes are assigned to the front wheels of the motor vehicle is then filled. Optionally, the pressure accumulators of both brake circuits can be filled to the predefined level in each case. Preferably, the secondary actuator comprise a pump for each of the brake circuits, wherein each pump is assigned its own controllable actuator, in particular an electric motor, or wherein the pumps are assigned a common controllable actuator, in particular an electric motor. In the latter case in particular, controlling one actuator results in the hydraulic volume being conveyed to both or all brake circuits by the relevant pump, as a result of which the total conveying volume is maximized.

Furthermore, according to an example embodiment of the present invention, it is preferably provided that, in the event that the motor vehicle comes to a standstill after step d) has been completed, the current temperature is detected again, and that, if the temperature is below the limit value, step b) is carried out again. As a result, once the motor vehicle has reached a standstill, the brake system is prepared again for the secondary actuator to provide the brake pressure on its own. This results in the advantages already mentioned above.

Preferably, according to an example embodiment of the present invention, after step d) has been completed, by means of the secondary actuator, hydraulic volume is drawn in from a reservoir assigned to the master brake cylinder and feeds the wheel brakes for their preconditioning. In particular, preconditioning is characterized in that the wheel brakes are subjected to a brake pressure that is at least sufficient to overcome a clearance of the relevant wheel brake. For example, a brake pressure of 3 bar is generated by the preconditioning. The corresponding valves, in particular changeover valves, are also actuated for preconditioning.

In a device according to the present invention, the control device is specially designed to perform the method according to the present invention when used as intended. This results in the advantages already mentioned above.

The brake system according to the present invention is characterized by the control device according to the present invention. This results in the advantages already mentioned above.

Further advantages and preferred features and combinations of features result in particular from the previously described features and from the rest of the disclosure herein. The present invention is explained in more detail below with reference to the figures.

### BRIEF DESCRIPTION OF THE DRAWINGS

FIG. 1 is a simplified representation of a brake system.

FIGS. 2A to 2C show a flow chart for explaining an advantageous method for operating the brake system according to an example embodiment of the present invention.

### DETAILED DESCRIPTION OF EXAMPLE EMBODIMENTS

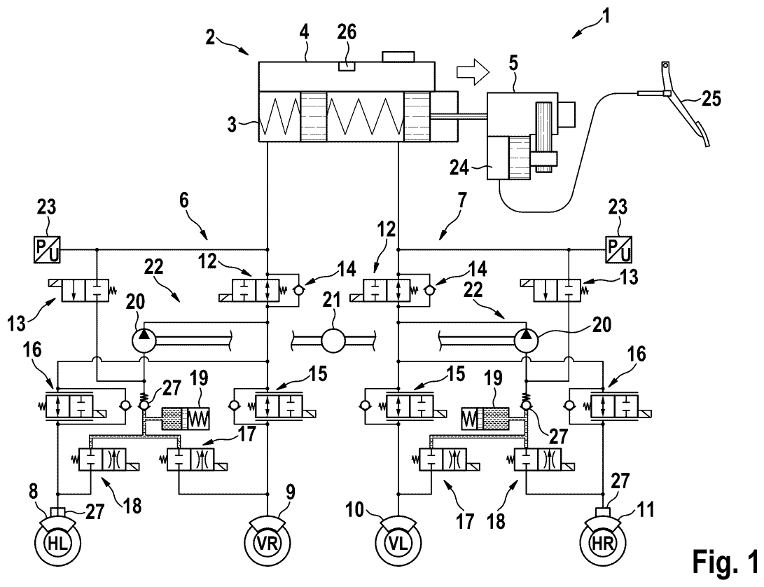

FIG. 1 shows a simplified representation of a brake system 1 for a motor vehicle not shown in detail here. The brake system 1 comprises a primary actuator 2, which is designed to generate hydraulic pressure in the brake system. For this purpose, the primary actuator 2 comprises a master brake cylinder 3, which is coupled to a reservoir 4 in which a hydraulic medium is kept ready, along with a controllable actuator 5 assigned to the master brake cylinder 3. The actuator 5 is designed in particular as an electromotive or electromechanical actuator, which serves to displace a single hydraulic piston or a tandem piston, as shown as an example in FIG. 1, in the master brake cylinder 3, so that a hydraulic volume is pushed out of the master brake cylinder 3 by the displacement.

The brake system 1 also comprises two brake circuits 6, 7, which are hydraulically connected to the master brake cylinder 3, in particular to different chambers of the tandem master brake cylinder 3. The two brake circuits 6, 7 are substantially identical, wherein the brake circuit 6 comprises wheel brakes 8, 9, of which the brake 8 is assigned to the left rear wheel HL and the brake 9 to the right front wheel VR of the motor vehicle, and the brake circuit 7 comprises wheel brakes 10, 11, wherein the wheel brake 10 is assigned to the left front wheel VL and the wheel brake 11 to the right rear wheel HR of the motor vehicle.

As the brake circuits are designed to be substantially identical, the structure of the brake circuits 6, 7 is explained below using only the brake circuit 6 as an example. With reference to the brake circuit 7, the same reference signs are used for the same elements.

The brake circuit 6 is or can be connected to the master brake cylinder 3 by a changeover valve 12, which is designed to be opened in a de-energized state, and a hydraulic valve 13, which is designed to be closed in a de-energized state. The hydraulic valves 12, 13 are connected in parallel to one another, wherein a non-return valve in a bypass is also assigned to the changeover valve 12. Two inlet valves 15, 16 are connected to the changeover valve 12, wherein the inlet valve 15 is connected upstream of the wheel brake for one of the front wheels, in this case the wheel brake 9, and the inlet valve 16 is connected upstream of the wheel brake for a rear wheel, in this case the wheel brake 8. The inlet valves 15, 16 are opened in a de-energized state and are in each case provided with a non-return valve in a bypass. If the changeover valve 12 and the inlet valves 15, 16 are open, hydraulic volume can thus be pushed from the master brake cylinder 3 into the wheel brakes 8, 9 by actuating the primary actuator 2, in order to generate brake pressure or braking force there, which acts on the front wheels LR, RF.

Furthermore, an outlet valve 17, 18, which is designed to be closed in a de-energized state, is connected in each case to the wheel brakes 8, 9. The outlet valves 17, 18 are both connected on the outlet side to a common pressure accumulator 19, which is designed as a mechanical pressure accumulator with a piston actuated by spring force. In addition, the outlet valves 17, 18 are connected to the hydraulic valve 13 and to the suction side of a pump 20. The pump 20 is operatively connected to a controllable actuator 21, which is designed in particular as an electric motor. The pump 20 and the electric motor 21 together form a secondary actuator 22 of the brake circuit 6.

On the pressure side, the pump 20 is connected to the brake circuit 6 between the changeover valve 12 and the inlet valves 15, 16. If the secondary actuator 22 is controlled, hydraulic medium is thus conveyed from the pump 20 in the brake circuit 6 in the direction of the inlet valves 16, 15 or in the direction of the wheel brakes 8, 9. Since the pump 20 is connected to the pressure accumulator 19 on the suction side, hydraulic medium is also removed from the pressure accumulator 19 during conveyance and fed to the brake circuit 6 on the pressure side. Excess hydraulic volume on the outlet side of the brake circuit 6 is also conveyed into the reservoir 4 in particular. Furthermore, the brake circuit 6 comprises a pressure sensor 23, by means of which the hydraulic pressure between the master brake cylinder 3 and the changeover valve 12 along with the hydraulic valve 13 can be detected.

The inlet valves 15, 16, the outlet valves 17, 18, the pressure accumulator 19 and the pump 20 preferably form part of an ESP system of the motor vehicle 1, and are arranged or formed in a common hydraulic block, for example.

The brake system 1 also comprises a control device 24, which is designed to control the primary actuator 2 and the valves 12, 13, 15, 16, 17, 18 of the brake circuits 6, 7 in accordance with a detected braking request, in order to generate or set a desired brake pressure or a desired brake force on the wheel brakes 8, 9, 10, 11 individually or for each wheel. The braking request is predefined or detected, for example, by actuating the brake pedal 25 of the brake system 1. The control device 24 is shown in FIG. 1 as belonging to the actuator 5. In principle, the control device 24 is arranged somewhere in or on the brake system 1 and can, for example, also be implemented by a central control device or an ESP control device of the brake system 1.

In the present case, the brake system 1 is a so-called brake-by-wire system, with which the primary actuator 2 is mechanically separated from the brake pedal 25. The braking request thus only reaches the control device 24 as a signal, but not the master brake cylinder 3 as an actuating force, as is the case, for example, with conventional brake systems, in which the brake pedal 25 is directly mechanically coupled to the master brake cylinder 3, possibly with the interposition of a brake booster. In this respect, the braking request can also be provided by an automated driving system of the motor vehicle in autonomous driving mode.

If the primary actuator 2 fails, for example because the actuator 5 or the master brake cylinder 3 is malfunctioning, in this case the user cannot generate any braking force mechanically on the wheel brakes 8, 9, 10, 11 by pressing the brake pedal 25. However, for this purpose, the control device 24 is designed to control the secondary actuator 22 of the relevant brake circuit 6, 7 to increase the hydraulic pressure in the relevant brake circuit 6, 7. For this purpose, the pump 20 draws in hydraulic volume from the master brake cylinder 3 through the hydraulic valve 13. Due to the relatively long hydraulic distance and at low temperatures and the associated stiffening of the hydraulic medium, this can lead to the brake pressure building up only slowly.

The method described below ensures that sufficient brake pressure is provided at sufficient speed even at particularly low temperatures on the wheel brakes 8, 9, 10, 11 if the primary actuator 2 fails.

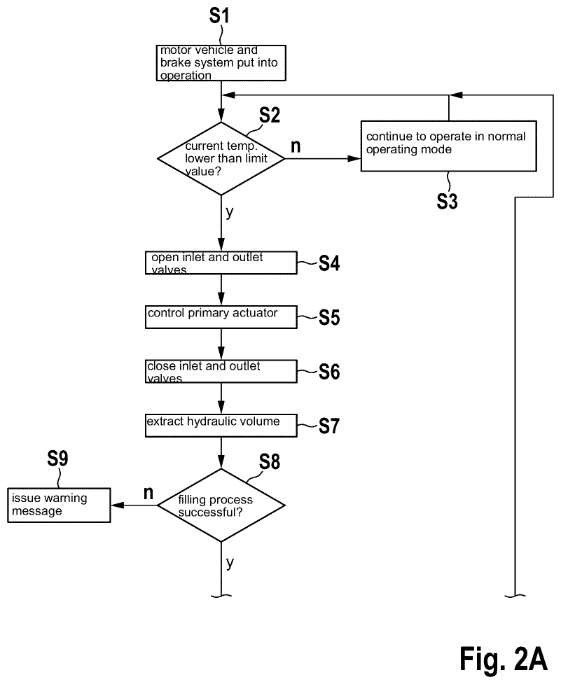

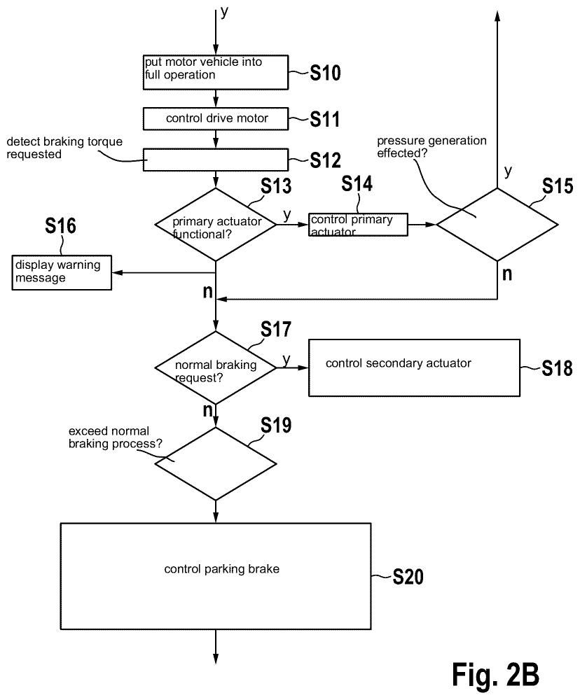

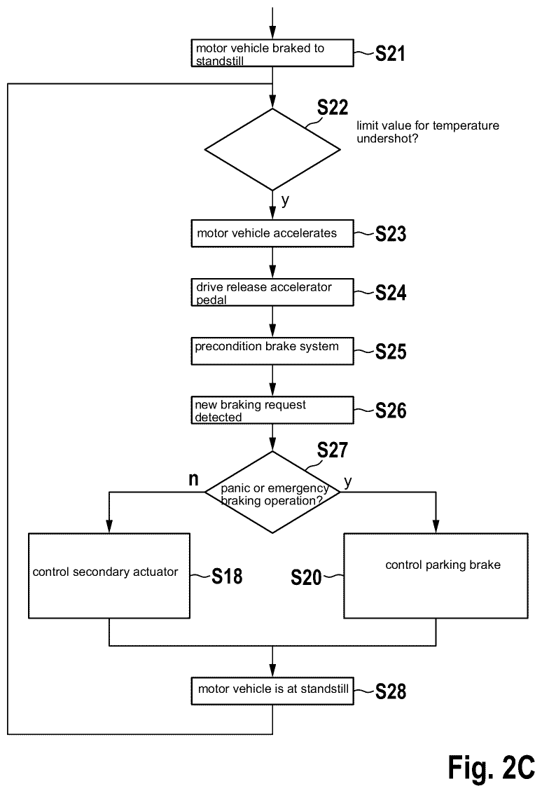

For this purpose, FIGS. 2A-2C show a flow chart in a plurality of sections, based on which the advantageous method is to be explained. The flow chart is divided into three parts, which are shown in FIGS. 2A, 2B and 2C.

In FIG. 2A, the method begins with a step S1, in which the motor vehicle and thus brake system 1 is put into operation. This is the case, for example, if the ignition of the motor vehicle 1 is engaged.

The current temperature T of the hydraulic medium is then ascertained in a step S2. For example, a temperature sensor 26 is used for this purpose, which is assigned to the reservoir 4, for example. The detected temperature is compared with a predefined limit value in step S2. A temperature of −20° C. is preferably assumed as the limit value TG. Below this, the hydraulic medium in brake systems, i.e. the brake fluid, usually loses viscosity and therefore requires more force for its conveyance. If the comparison shows that the current temperature T is higher than the limit value TG, the brake system 1 continues to operate in a normal operating mode according to step S3, provided that the primary actuator 2 and the brake circuits 6, 7 are functional.

However, if the comparison in step S2 shows that the current temperature T is lower than the predefined limit value TG (y), all inlet valves 15, 16 and outlet valves 17, 18 are initially opened in a step S4. Subsequently, the primary actuator 2 is controlled in a step S5 to convey a predetermined hydraulic volume VH into the pressure accumulator 19.

For this purpose, the piston is moved a predetermined distance by the actuator 5 in accordance with the cross-sectional area of the piston, so that the volume to be conveyed into the pressure accumulator 19 results from the displaced hydraulic volume. For example, a volume of VH=3.67 cm³ is assumed as the hydraulic volume VH.

In a subsequent step S6, the inlet and outlet valves 15 to 18 are closed again and the actuator 5 is controlled in such a way that the master brake cylinder 13 is moved back to its starting position. The predefined hydraulic volume HV now remains in the pressure accumulator 19. So that that the hydraulic medium remains in the pressure accumulator 19, a spring force of the pressure accumulator 19 and that of a non-return valve 27 located between the pump 20 and the hydraulic valve 13 are matched to one another.

In the event that the brake shoes of the wheel brakes 8 to 11 move so easily that it is not possible to clearly distinguish whether the pressure accumulator 19 has been filled or the wheel brakes 8 to 11 have been actuated by the displaced hydraulic volume, the pressure accumulator 19 is optionally filled until a defined pressure is present in the brake circuit 6, 7, so that it is ensured that both the brake pads of the wheel brakes 8 to 11 are applied and that the pressure accumulator 19 has been completely filled.

After the pressure accumulator 19 has been completely filled, the outlet valves 17, 18 are closed again and the primary actuator 2 is returned to its starting position. Only then is the hydraulic volume conveyed to the pressure accumulator 19 extracted in step S7 with the aid of the secondary actuator 20 and, in particular, conveyed back to the reservoir 4. Thereafter, the desired hydraulic volume VH remains in the pressure accumulator 19. In accordance with the pressure required to completely fill the pressure reservoir 19, unintended actuation of the wheel brakes 8, 9, 10, 11 can occur depending on the vehicle. In order to minimize or avoid this effect, the pressure accumulator 19 is preferably filled by each or only one of the brake circuits 6, 7 in this preparation process.

In the subsequent query in a step S8, it is checked whether the filling process of the pressure reservoir 19 was successful. If the brake system 1 is functional, the desired hydraulic volume now remains permanently in the pressure accumulator 19 and serves as a dynamic volume reserve in the event that the primary actuator 2 is not available due to a malfunction.

If a braking request is now detected, the secondary actuator 22 draws in hydraulic volume not from the master brake cylinder 3, but from the pressure accumulator 19. Since the hydraulic connection in this case is significantly shorter than that to the master brake cylinder 3, a more rapid pressure build-up is effected, as a result of which the desired braking force can be ensured rapidly and to a sufficient extent even at particularly low temperatures.

In the event that the brake system 1 has an undesired leakage and the desired hydraulic volume cannot be permanently maintained in the pressure accumulator 19, the changeover valves 12 and the inlet valves 16, 15 are preferably energized in order to prevent the pressure accumulator 19 from being emptied unintentionally. If a fault is detected, a warning message is also issued to the driver of the motor vehicle in a step S9.

However, if filling was successful (y), the operation of the motor vehicle continues as shown in FIG. 2B. In a step S10, the motor vehicle is initially put into full operation, for example a drive unit is also started and the functionality of the motor vehicle is determined. Optionally, the motor vehicle 1 is accelerated actively by controlling the drive motor or passively by releasing a braking force or a parking brake on the slope according to step S11. If, in a subsequent step S12, it is detected that a braking torque is requested, in particular by the driver of the motor vehicle, the following procedure is followed:

Initially, the functionality of the primary actuator 2 is checked in a step S13. If it is functional (y), the primary actuator is controlled in a step S14 to generate the desired brake pressure in the hydraulic system or in the brake system 1. A subsequent query S15 checks whether the pressure generation has been effected. If this is confirmed (y), the method is repeated or brake system 1 is operated normally. However, if the query shows that the desired brake pressure has not been generated or has not been fully generated (n), for example with the aid of the pressure sensor 23, the secondary actuator 22 is controlled to increase the brake pressure or the hydraulic pressure in the brake circuit 6, 7.

If a technical defect of the primary actuator 2 is determined, a warning message is also preferably displayed to the driver of the motor vehicle in a step S16. If it is recognized in a step S17 that the braking request corresponds to a normal braking request, the secondary actuator 22 is controlled in a step S18, preferably in the sense of a conventional ESP power request. The hydraulic valves 13 are opened and the changeover valves are closed. For example, the secondary actuator is driven by the actuator 21 at a power of 3000 revolutions per minute. This is sufficient to remove hydraulic medium from the pressure accumulator 19 at a sufficient speed and pressure and convey it into the brake circuit 6, 7.

If it is recognized in a step S19 that the braking request exceeds a normal braking process, for example an emergency braking operation, because the driver presses the brake pedal 25 with maximum force or maximum speed, the changeover valves 12 are closed, the hydraulic valves 13 are opened and only the inlet valves 15 assigned to the front wheels VL, VR of the motor vehicle are opened. At the same time, a parking brake device 27 assigned to the rear wheels, which is designed in particular as an electromechanical parking brake, is controlled in order to generate a braking torque on the rear wheels. The parking brake is controlled in a step S20 to generate the maximum possible clamping force.

As a result of the hydraulic valve 13 being open, the advantage arises that as soon as the master brake cylinder 3 is moved from a rest position, as a result of which at least one so-called sniff bore is opened to the reservoir, and as soon as the pressure accumulator 19 is empty, further hydraulic volume is automatically drawn in from the reservoir 4 by the secondary actuator 22. A non-return valve is optionally connected between the master brake cylinder 3 and the reservoir 4, through which hydraulic volume can also be drawn in before the sniff bore is released. Therefore, the switching of the hydraulic valve 13 does not have to be effected in accordance with an estimated filling volume of the pressure accumulator 19. However, if there is a way to reliably monitor the fill level of the pressure accumulator 19, the hydraulic valves 13 are preferably only opened if the pressure accumulator 19 has been fully drained.

Due to efficiency requirements and the associated use of brake calipers of wheel brakes with low residual grinding torque on the wheel and a resulting large clearance, the hydraulic volume HV stored in the pressure accumulator 19 may not be sufficient to generate a desired or requested brake pressure on the wheel brakes 8, 9, 10, 11. In order to ensure that a desired braking torque is nevertheless generated, only the inlet valves of the wheel brakes 8, 9, which are assigned to the front wheels VL, VR, are opened and, as already mentioned above, the parking brake 27 on the rear wheels HL, HR is activated, so that a rapid and high pressure build-up is effected on the wheel brakes as a whole. This allows the motor vehicle to be braked hydraulically and electromechanically with maximum deceleration, for example, in accordance with its current weight and the possible brake pressure, even if the primary actuator 2 has failed. In particular, if the wheel brakes 8 to 11 of the front or rear wheel axle are not yet in ABS control, as soon as the sniff bore of the master brake cylinder 3 is opened, the missing hydraulic volume can be drawn in from the reservoir 4, in order to carry out ABS control on both axles of the motor vehicle.

If the motor vehicle is braked to a standstill in a step S21 using the method described above, the current temperature T of the hydraulic medium is ascertained again in a step S22 and compared with the limit value TG. In the event that the limit value TG is undershot again or is still undershot (y), and if the motor vehicle accelerates again in a subsequent step S23 or the driver releases the accelerator pedal in a step S24, the brake system 1 is preconditioned in a step S25 by drawing in hydraulic volume from the reservoir 4 by means of the secondary actuator 22 and displacing this hydraulic volume into the relevant wheel brake 8-11, in particular for closing a clearance of the relevant wheel brake 8-11.

If a new braking request is then detected in a subsequent step S26, a subsequent step S27 ascertains whether the braking request is a normal braking operation or a panic or emergency braking operation, in particular in accordance with a detected actuation force or actuation speed of the brake pedal 25. If it is a normal braking operation (n), step S18 is carried out again. However, if emergency braking operation is detected (y), step S20 is carried out again. As soon as it is determined in a further step S28 that the motor vehicle is at a standstill again, the method is repeated with step S22.

What is claimed is:

1. A method for operating a hydraulic brake system of a motor vehicle, wherein the brake system includes a hydraulic primary actuator, which includes a master brake cylinder and an actuator that can be controlled for operating the master brake cylinder, and at least one brake circuit that is or can be hydraulically connected to the master brake cylinder and has at least one hydraulically actuated wheel brake, wherein the at least one brake circuit includes at least one secondary actuator and, assigned to each of the at least one wheel brake, at least one controllable inlet valve and at least one controllable outlet valve, wherein the secondary actuator can be controlled to convey hydraulic volume in the direction of the inlet valve, and wherein the at least one brake circuit includes a hydraulic pressure accumulator connected downstream of the outlet valve, wherein the following steps are carried out in succession upon each startup of the motor vehicle:
a) ascertaining an actual temperature of the hydraulic medium and comparing the ascertained temperature with a predefined limit value, and only when the ascertained temperature is below the limit value:
b) controlling the primary actuator and the at least one brake circuit in such a way that hydraulic medium is conveyed into the at least one brake circuit, until the pressure accumulator is filled to a predefined level with hydraulic medium,
c) after step b), monitoring the functionality of the primary actuator and/or the master brake cylinder, and only when a malfunction of the primary actuator is recognized:
d) controlling the secondary actuator in such a way that the secondary actuator conveys hydraulic medium from the pressure accumulator in the direction of the inlet valve into the at least one brake circuit.

2. The method according to claim 1, wherein, in step b), the primary actuator is controlled in such a way as to convey a predefined hydraulic volume from the master brake cylinder into the pressure accumulator.

3. The method according to claim 1, wherein, in step b), the pressure accumulator is initially completely filled and then emptied to the predefined level by controlling the secondary actuator.

4. The method according to claim 1, wherein, in step d), a simple braking operation or an emergency braking operation is carried out in accordance with a detected braking request.

5. The method according to claim 4, wherein the brake system includes at least two wheel brakes for front wheels of the motor vehicle and at least two wheel brakes for rear wheels of the motor vehicle, and for a simple braking operation, the hydraulic volume is conveyed through the secondary actuator into all wheel brakes of the brake system.

6. The method according to claim 4, wherein the brake system includes at least two wheel brakes for front wheels of the motor vehicle and at least two wheel brakes for rear wheels of the motor vehicle, and for a simple braking operation, the hydraulic volume is conveyed by the secondary actuator only into the wheel brakes for the front wheels.

7. The method according to claim 1, wherein, in step d), an electromechanical parking brake, at least on the rear wheels of the motor vehicle, is additionally activated.

8. The method according to claim 1, wherein, in step d), at least one changeover valve, which is connected between the at least one brake circuit and the master brake cylinder and is assigned to the secondary actuator on a pressure side, is closed.

9. The method according to claim 1, wherein, in step d), at least one hydraulic valve, which is connected between the at least one brake circuit and the master brake cylinder. which is assigned to the secondary actuator on a suction side, is opened.

10. The method according to claim 9, wherein the hydraulic valve is opened only when the hydraulic volume stored in the pressure accumulator has been conveyed by the secondary actuator into the at least one brake circuit.

11. The method according to claim 1, wherein the brake system includes at least two brake circuits, which are configured like the at least one brake circuit, and in that each of the two brake circuits or only one of the pressure accumulators is filled to the predefined level in step b).

12. The method according to claim 1, wherein, in the event that the motor vehicle comes to a standstill after step b) has been completed, the current temperature is detected again, and in that, when the temperature is below the limit value, step b) is carried out again.

13. The method according to claim 1, wherein after step d) has been completed, hydraulic volume is drawn in using the secondary actuator from a reservoir assigned to the master brake cylinder and fed to the wheel brakes for their preconditioning.

14. A device for operating a hydraulic brake system of a motor vehicle, comprising:
a control device configured to operate a hydraulic brake system of a motor vehicle, wherein the brake system includes a hydraulic primary actuator, which includes a master brake cylinder and an actuator that can be controlled for operating the master brake cylinder, and at least one brake circuit that is or can be hydraulically connected to the master brake cylinder and has at least one hydraulically actuated wheel brake, wherein the at least one brake circuit includes at least one secondary actuator and, assigned to each of the at least one wheel brake, at least one controllable inlet valve and at least one controllable outlet valve, wherein the secondary actuator can be controlled to convey hydraulic volume in the direction of the inlet valve, and wherein the at least one brake circuit includes a hydraulic pressure accumulator connected downstream of the outlet valve, wherein the control device is configured to perform the following steps are carried out in succession upon each startup of the motor vehicle:
a) ascertaining an actual temperature of the hydraulic medium and comparing the ascertained temperature with a predefined limit value, and only when the ascertained temperature is below the limit value:
b) controlling the primary actuator and the at least one brake circuit in such a way that hydraulic medium is conveyed into the at least one brake circuit, until the pressure accumulator is filled to a predefined level with hydraulic medium,
c) after step b), monitoring the functionality of the primary actuator and/or the master brake cylinder, and only when a malfunction of the primary actuator is recognized:
d) controlling the secondary actuator in such a way that the secondary actuator conveys hydraulic medium from the pressure accumulator in the direction of the inlet valve into the at least one brake circuit.

15. A brake system for a motor vehicle, wherein the brake system comprises:
a hydraulic primary actuator, which includes a master brake cylinder and an actuator that can be controlled for operating the master brake cylinder; and
at least one brake circuit that is or can be hydraulically connected to the master brake cylinder and has at least one hydraulically actuated wheel brake, wherein the brake circuit includes at least one secondary actuator and, assigned to each wheel brake, at least one controllable inlet valve, and at least one controllable outlet valve, wherein the secondary actuator can be controlled to convey hydraulic volume in a direction of the inlet valve, and wherein the brake circuit includes a hydraulic pressure accumulator connected downstream of the outlet valve; and
a device including a control device configured to operate a hydraulic brake system, the control device being configured to perform the following steps are carried out in succession upon each startup of the motor vehicle:
a) ascertaining an actual temperature of the hydraulic medium and comparing the ascertained temperature with a predefined limit value, and only when the ascertained temperature is below the limit value:
b) controlling the primary actuator and the at least one brake circuit in such a way that hydraulic medium is conveyed into the at least one brake circuit, until the pressure accumulator is filled to a predefined level with hydraulic medium,
c) after step b), monitoring the functionality of the primary actuator and/or the master brake cylinder, and only when a malfunction of the primary actuator is recognized:
d) controlling the secondary actuator in such a way that the secondary actuator conveys hydraulic medium from the pressure accumulator in the direction of the inlet valve into the at least one brake circuit.
